(19) United States
(12) Patent Application Publication
(10) Pub. No.: US 2012/0144306 A1
(43) Pub. Date: Jun. 7, 2012

(54) METHOD AND SYSTEM FOR INTERACTING OR COLLABORATING WITH EXPLORATION

(76) Inventors: MICHAEL JAMES MOODY, SAWSTON (GB); PATRICK DANIEL DINEEN, KATY, TX (US); FLOYD LOUIS BROUSSARD, III, THE WOODLANDS, TX (US); HORACIO RICARDO BOUZAS, OSLO (NO)

(21) Appl. No.: 13/303,980

(22) Filed: Nov. 23, 2011

Related U.S. Application Data
(60) Provisional application No. 61/418,958, filed on Dec. 2, 2010.

(51) Int. Cl. G06F 3/033; G06F 3/048

(52) U.S. Cl. 715/733

(57) ABSTRACT

Embodiments of the present disclosure may include methods, systems, and computer-readable media that enable executing oilfield software on a first computing device; communicably coupling the first computing device with a second computing device, the second computing device comprising a touch interface; receiving input from a user via the touch interface; and causing the oilfield software to perform an action in response to the input. Embodiments of the present disclosure may also include methods, systems, and computer-readable media that enable presenting a result of the action via a second touch interface of a third computing device communicably coupled to at least one of the first and second computing devices.

### CROSS-REFERENCE TO RELATED APPLICATION

This application claims the benefit of U.S. Provisional Patent Application Ser. No. 61/418,958 filed Dec. 2, 2010, entitled “Multitouch Devices to Control Software,” the entirety of which is incorporated by reference herein.

### BACKGROUND

Conventional user interface modality for operating a desktop computer or laptop may include a keyboard, mouse and/or trackpad. For certain software programs, certain graphical user interface (GUI) elements may be difficult to navigate with conventional keyboard, mouse and/or trackpad hardware user interface (HUI). This may be due to a hierarchical organization of one or more GUI elements. Another issue is the limited amount of display area that traditional screen displays may offer for organizing one or more processes, modes and tools related to a GUI. For example, although one or more GUI elements may be presented in a display area, it may be difficult to display one or more GUI elements legibly on a screen if there are too many such GUI elements.

### SUMMARY

Embodiments of the present disclosure may include methods, systems, computer-readable media that enable executing oilfield software on a first computing device; communicably coupling the first computing device with a second computing device, the second computing device comprising a touch interface; receiving input from a user via the touch interface; and causing the oilfield software to perform an action in response to the input. Embodiments of the present disclosure may also include methods and systems that include presenting a result of the action via a second touch interface of a third computing device communicably coupled to either the first or second computing device.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates an interface device for interacting with exploration and/or production data according to an embodiment of the present disclosure.

FIG. 2 illustrates a GUI related to an Explorer Companion app according to an embodiment of the present disclosure.

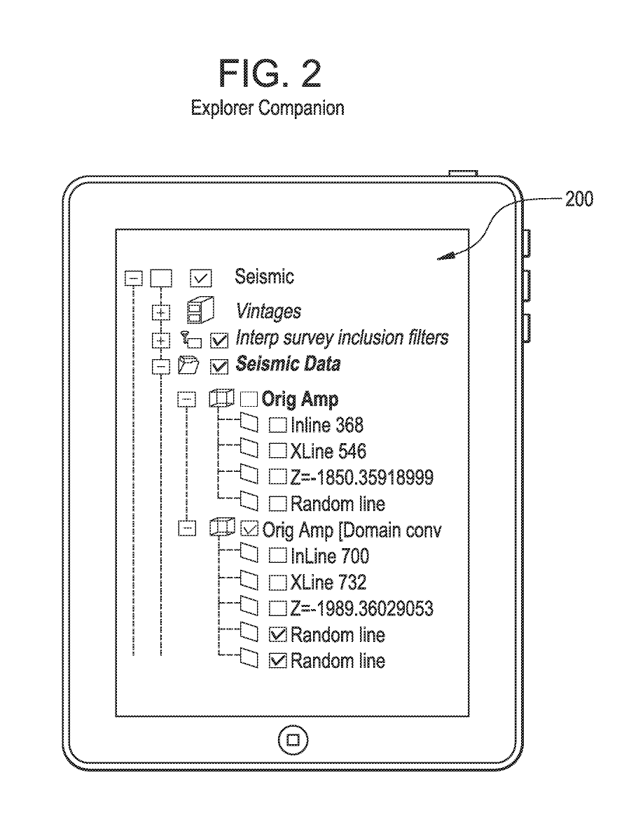

FIG. 3 illustrates a GUI related to a Window Manager Companion app according to an embodiment of the present disclosure.

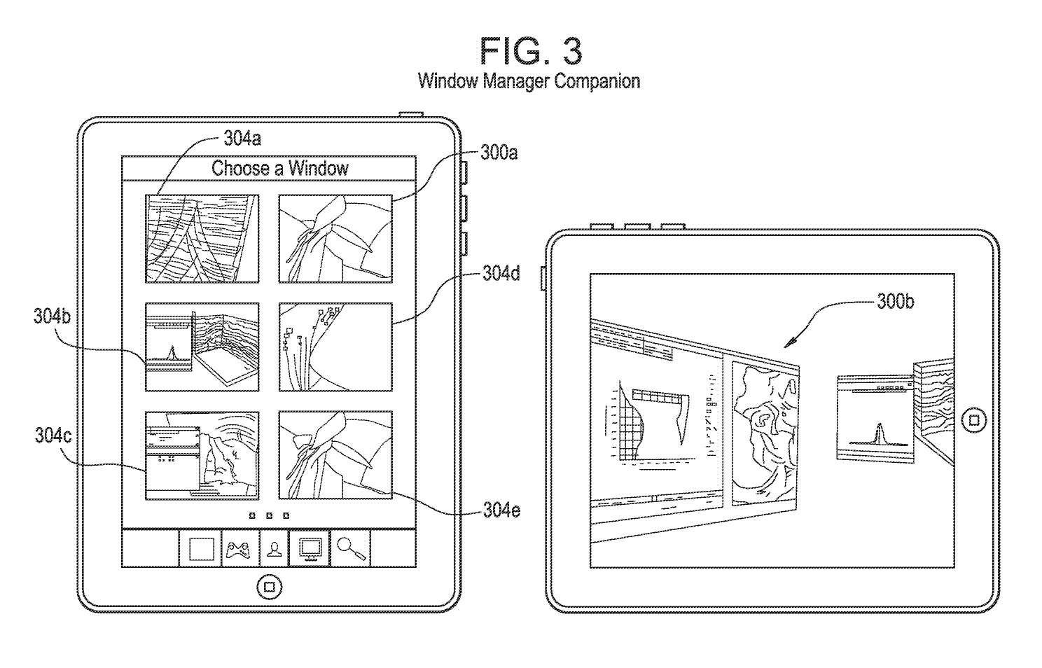

FIG. 4 illustrates a GUI related to a Notes Companion app according to an embodiment of the present disclosure.

FIG. 5 illustrates a GUI related to a Control Companion app according to an embodiment of the present disclosure.

FIG. 6 illustrates a GUI related to a Tool Companion app according to an embodiment of the present disclosure.

FIG. 7 illustrates a GUI related to a Help Companion app according to an embodiment of the present disclosure.

FIG. 8 illustrates method for interacting with exploration and/or production dataaccording to an embodiment of the present disclosure.

FIG. 9 illustrates method for collaborating with exploration and/or production dataaccording to an embodiment of the present disclosure.

FIG. 10 illustrates a computer system into which implementations of various technologies and techniques described herein.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

### Introduction

Embodiments of the present disclosure may include controlling software executing on a computing device using an interface device that provides an additional GUI and/or HUI. In an embodiment, the software may include oilfield software, including, without limitation, software that enables interaction with exploration and/or production (E&P) data, including, without limitation, E&P interpretation models and information.

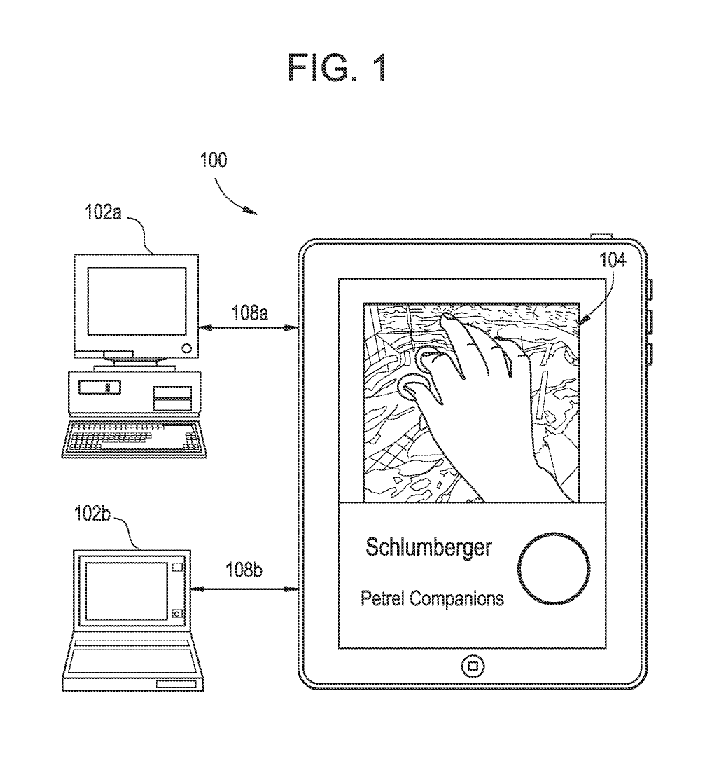

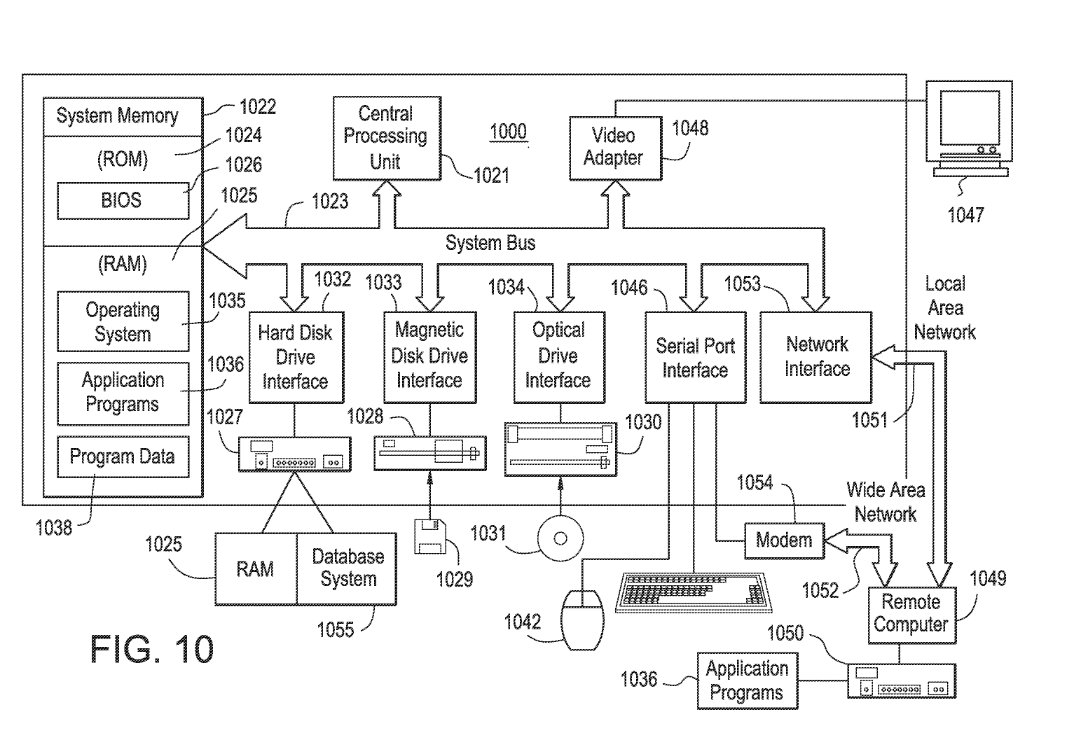

A computing device, such as the computing devices 102a-b shown in FIG. 1, and computing device 1000 shown in FIG. 10, may include any computing device known in the art, including, without limitation, a desktop computer, a laptop, a smartphone, or any other mobile computing device. An interface device, such as the interface device 100 shown in FIG. 1, may include any computing device that may be configured to communicably couple with a computing device, and may include, without limitation, desktop computer, a laptop, a tablet, a smartphone, a display that includes a touch interface, etc. In an embodiment, an interface device may include a touch interface 104 adapted to receive touch input. A touch interface may include one or more of the following technologies: Bending Wave Touch, Dispersive Signal Touch (DST), In-Cell, Infrared Touch (IR), Optical touch technology, Near Field Imaging (NFI), Optical Imaging, Projected Capacitive Touch (PST), Resistive Touch, Surface Acoustic Wave Touch (SAW), Surface Capacitive Touch. In another embodiment, a touch interface may include a multi-touch interface configured to receive multi-touch input.

According to an embodiment, an interface device may use the “iOS” operating system, which is developed and distributed by APPLE, INC. However, other multi-touch operating systems are also possible, including, without limitation, MICROSOFT WINDOWS 7, MICROSOFT WINDOWS 8, ANDROID, PALMOS, etc. Although embodiments of the present disclosure may include an interface device having touch capabilities, other computing devices may also be used as interface devices.

A two-way communication link 108a-b between the interface device and the computing device may pass user interface events and/or media, such as images, text and audio. Such two-way communication may include one or more secured and/or non-secured wired and/or wireless communication technologies. In an embodiment, a two-way communication link may include a Wi-Fi communication link. In another embodiment, two-way communication may include establishing a communication link using a Bluetooth connection. In other embodiments, two-way communication may be implemented using other communication technologies known in the art.

In an embodiment, the two-way communication link 108a-b may implement a short-range communication protocol, such as Near Field Communication (NFC), or Radio Frequency Identification (RFID). The two-way communication link 108a-b may automatically establish a connection between an interface device and a computing device when the devices are placed within a predetermined proximity with respect to each other (e.g., within a predetermined number of centimeters, inches, etc.).

Upon establishing a two-way communication link, an interface device and a computing device may communicate using one or more secure and/or non-secure protocols. In an embodiment, communication may include Hyper Text Transport Protocol (HTTP), Remote Desktop Protocol (RDP), NFC, RFID, and/or other protocols.

The communication between an interface device and a computing device may facilitate use of an interface device to control functionality of software operating a computing device. As an example, a server may be instantiated on a computing device, and may be adapted to listen for commands from the interface device. When the server receives a command from the interface device, the server may cause software operating on a computing device to perform certain actions in response to the command. The server may include a web server or similar technology. In another embodiment, rather than having a server reside on a computing device executing software to be controlled, the server may instead execute on an interface device.

Embodiments of the present disclosure may enable a user to control, with an interface device, software executing on another computing device. For example, an interface device may include a touch interface that is configured to provide input to interface software. According to an embodiment, interface software may include touch interface software that is adapted to process touch input received via a touch interface. The input may then be processed by the touch interface software to control the software executing on a computing device. Furthermore, an interface device may include a display that can be used to display user interface elements related to software executing on a computing device, thereby extending usable user interface screen space available to a user.

Software operating on a computing device may include a seismic-to-simulation software suite, such as PETREL software (which may be referred to herein as “Petrel”), which is developed and distributed by SCHLUMBERGER LTD and its affiliates. The present disclosure will provide examples that reference Petrel as the software executing on the computing device that is to be controlled. However, Petrel is merely one example, and other types of oilfield software other than Petrel are also within the scope of the present disclosure, including, without limitation, ECLIPSE, GEOFRAME, INTERSECT, PIPESIM, TECHLOG, MALCOM, etc.

In an embodiment, software executing on a computing device may include a keyboard and mouse interface that implements a plurality of mouse clicks and movements to change the state of such software before an action can be performed on an object in a window. To reduce the number of repetitive mouse controls, a user may use an interface device equipped with interface software to control the software.

In another embodiment, software executing on a computing device may allow a user to interact with the software using keyboard “shortcuts.” Such keyboard shortcuts may be executed with respect to the software by performing certain actions on the interface device (e.g., by entering a gesture via a touch interface associated with an interface device). In such an embodiment, a gesture may be mapped to a keyboard shortcut.

Other methods of controlling software are also possible. For example, an interface device equipped with touch capabilities may allow a user to interact with various user interface elements, such as dialog windows, slider bars, text boxes, etc., in a way that is more conducive to touch interfaces.

The touch capabilities of an interface device may enable additional ways to perform an action. For example, pinching the screen of the interface device might zoom in on a user interface element. In another example, swiping a pre-determined number of fingers on the screen might cycle to a new user interface screen. In yet another example, performing an action with one or more fingers on a touch interface could open a menu related to the oilfield software user interface. These actions can enable efficient change-of-state operations, such as finding elements within a user interface pane, and activating an elements settings dialog.

In an embodiment, interface software may include one or more applications, (which may be referred to herein as “companions” or “apps”) that facilitate operations within the software user interface. In an embodiment, the companions may utilize the OCEAN software framework which is developed and distributed by SCHLUMBERGER LTD and its affiliates.

In an embodiment, interface software may include an “Explorer Companion” app, a “Favorites Companion” app, a “Windows Manager Companion” app, a “Notes Companion” app, a “Control Companion” app, a “Tool Companion” app, and a “Help Companion” app. Although the various Companion apps are described in detail below in various sections, it should be understood that functionality described below may be incorporated into any of the apps, and that the descriptions below are merely to organize discussion of various aspects of embodiments according to the present disclosure.

### Explorer Companion App

A Petrel software task may include interacting with a Petrel software “Explorer” window. Mouse operations related to interacting with the Explorer window may include scrolling to find an element within a tree; selecting elements in the tree; showing or hiding elements by tagging their associated check-boxes; and opening settings dialogs. Certain operations may involve precise movement of the mouse and/or precise button presses to interact with relatively small-sized text and icons.

An interface device may present a user with a version of the Explorer window that is adapted for a touch interface. In an embodiment, an Explorer Companion app 200 may provide a GUI that takes advantage of touch gesture controls, since certain aspects of a touch-enabled GUI may be faster to navigate, easier to understand, and may involve less physical movement than user interaction via a mouse and/or keyboard. For example, in certain situations, scrolling may be simpler and easier using a swipe gesture. In another example, a user may use a gesture drawn on a touch interface to instantiate one or more menus associated with such gesture. In an embodiment, interface software may be configured to process data provided by hardware such as gyroscopes and/or accelerometers to provide physics-based user interface controls.

In another embodiment, a font size used in a Explorer Companion app may be increased (as compared to the font size used in a GUI presented by software executing on a computing device), so that it is easier for a user to read. Further, the Explorer Companion app may resize portions of the Explorer window, and present a larger interface area for a user to press. The resized Explorer window and/or increased font size may be rendered on the interface device in a manner that simplifies user interaction with elements of the Explorer window (e.g., a tree control).

### Favorites Companion App

Generally, the Favorites Companion app may be used to apply an “attribute” to at least a portion of a first dataset based upon input received by an input device user. Such an attribute or tag may help identify certain data related to the dataset. The first dataset may be data imported to an interface device. Upon applying one or more attributes to a portion of the dataset via the interface device, a corresponding attribute may then be applied to at least a portion of a second dataset based upon the portion of the first dataset. The second dataset, according to an embodiment, may be associated with software operating on a computing device. For example, the attributes may be applied to equivalent portions of data within the first and second dataset. In such an embodiment, a first dataset and a second dataset may be effectively synchronized to reflect the same attributes for the same portion(s) of such datasets.

An aspect of an embodiment may include exporting certain data from a computing device to an interface device, so that such data may be organized on the interface device. A user may organize such data using an interface device (e.g., via the Explorer Companion app 200), and after such data has been organized, the interface device may synchronize the organized data with a computing device. Another embodiment of the foregoing may include exporting data from a computing device to an interface device, identifying certain data as “favorite” data (i.e., applying a “favorite” attribute to such data), and synchronizing the favorite data between the computing device and the interface device. As an example, the data may include well data and/or seismic data.

### Window Manager Companion App

In an embodiment, a Window Manager Companion app 300a-b may facilitate window-switching related to software operating on a computing device. For example, a Petrel software user might have a plurality of windows open in connection with displaying a workflow. Using a mouse or keyboard to switch between these windows may be a cumbersome and repetitive process.

According to an embodiment, a Window Manager Companion app 300a may display one or more thumbnails 304a-e on an interface device, wherein the one or more thumbnails correspond to GUI windows related to a software instance executing on a computing device. An interface device may present a GUI that includes one or more pages of thumbnails, and each page of thumbnails may display a predetermined plurality of thumbnails. The one or more thumbnails may be synchronized at predetermined intervals to reflect the status of the windows related to a software instance. In another embodiment, the Window Manager Companion app 300b may present a GUI on an interface device, wherein the GUI tracks in at least substantially real-time the status of one or more windows related to a software instance executing on a computing device.

Pressing a thumbnail on the interface device may raise the corresponding window to a predetermined position on a screen displaying output related to a software instance operating on a computing device (e.g., the top of the screen). When a software instance has more than a predetermined plurality of windows open, a user may use a gesture (e.g., a swipe gesture) on an interface device to display a second page containing a second plurality of thumbnails corresponding to the second set of windows open on the computing device.

A user may be able to use an interface device to reorder one or more thumbnails, or create one or more groups of thumbnails. Thumbnail grouping may be used to enable custom views of windows related to a Petrel software instance (e.g., side-by-side tiling of 2D and/or 3D canvases).

According to an embodiment, a first interface device may share status information related to a process event model with a second interface device. As an example, the first interface device may share the status of a process tool with the second interface device (i.e., describe whether the process tool is active or not). The status information may be dependent on one or more criteria defined by the first computing device, such as window selected, process mode enabled and data highlighted, etc.

Upon receiving the status information, the second touch interface may modify a user interface element in accordance with the status information. In addition, a user of the second touch interface device may further modify a user interface element, and share updated status information with the first touch interface device, so that the first touch interface device may in turn update a user interface element according to the updated status information.

As another example, the first touch device may provide to the second interface device certain information related to the Petrel software instance, such as information about a model. The second interface device may receive input from a user via a second touch interface related to the second interface device. The second interface device may then provide information related to that input to the first touch device and/or the Petrel software instance. As a result, information related to the Petrel software instance may be modified at the second interface device, and then updated at the first interface device and/or the Petrel software instance.

### Notes Companion App

Physical notes (e.g., a POST-IT note) are a convenient way of recording information in an informal manner. A physical note can contain several different types of information, including, without limitation, text, an image, and a sketch. When performing a task, certain people may need to write down a note. However, a physical note may have certain limitations. For example, to share information written on a physical note posted on a physical board may involve people visiting the board to read the physical note.

Electronic notes 404a-g, such as tags 404a, 404b, conversation logs 404c, sketches 404d, 404e and annotations 404f, 404g, may be combined with other communication technologies, such as e-mail, chat, or electronic bulletin boards, and may facilitate communication among a plurality of people. Another disadvantage inherent to a physical note is that it may have a short life span, and may be easily misplaced. In contrast, electronic notes may remain relevant for a much longer time. A Notes Companion app 400 may provide functionality of a virtual workspace that is integrated with Petrel software's “Annotate” feature (Petrel software's annotate feature enables a user to annotate data processed by Petrel software).

Electronic notes may originate in either the interface device software or software instance operating on another computing device. According to an embodiment, electronic notes may be synchronized between the interface software and software executing on another computing device. For example, a user may use the “Annotate” feature to associate an electronic note with an object in Petrel software, and send the electronic note to a virtual workspace. In another example, a user may use the Note Companion app to attach a note to a currently selected object in a Petrel scene, and send the note to a virtual workspace. The selected object may include multimedia, such as an image, document, sound, etc.

A virtual workspace may serve as a media display that supports multiple document formats, including, without limitation, ADOBE PORTABLE DOCUMENT FORMAT (PDF), MICROSOFT WORD and MICROSOFT POWERPOINT, as well as audio, videos, and images provided in various file formats. According to an embodiment, the Notes Companion app may include electronic note creation tools that allow a user to record and/or import voice, video, and image media files, and associate such media with a virtual workspace. A user may then view such media files and other files associated within the virtual workspace.

An example of the foregoing may include recording information about a well attribute (e.g., recording a screen shot of a well control point within Petrel software), and creating a document that records information about an aspect of the well attribute (e.g., a change request of a dog leg severity related to a well control point). The document and other related information may then be associated with a virtual workspace and annotated by one or more users. For example, a user may annotate the information (e.g., draw shapes or enter text notations to identify certain portions of such information).

One or more other users may be allowed access to a virtual workspace, thereby enabling such users to share annotated information. Sharing may be facilitated via email or other communication technology. In an embodiment, annotated information may be shared via a proprietary file format. For example, the annotated information may be exported to PDF, or any other format known in the art. In other embodiments, a custom file format may be created to facilitate sharing of annotated information and/or virtual workspaces among oilfield software. The custom file format may be created using one or more compression technologies.

The Notes Companion app may also associate one or more forms of metadata with shared information. In an embodiment, in addition to sending a bitmap image associated with a screen shot, the Notes Companion app may also record context-related information, such as what data was visible in a 3D window related to the shared information. Other context-related information may include information about a camera view at the time the information was recorded (e.g., a Petrel software camera view). The foregoing are merely examples, and it should be understood that other context-related information may also be associated with the shared information. In an embodiment, Petrel software may be adapted to analyze the shared information and the context-related information, and create one or more objects from the foregoing, or portions thereof.

The Notes Companion app may also facilitate collaboration by enabling a user to present certain data to one or more other users. One or more of the other users may have access to an interface device configured to enable a presenting user and/or the other users to provide input related to presented data. Input may include real-time annotation of the presented data by the one or more other users. The collective input, or a portion thereof, may be stored for review at a later time. Furthermore, the Notes Companion app may provide one or more collaboration tools, such as virtual laser pointers that enable one or more of the other users to point to certain presented data.

### Control Companion App

Certain touch computing devices may be controlled using gesture controls. Furthermore, certain computing devices, such as laptops and desktops, can be controlled using a touch trackpad. In addition, certain operating systems, such as OSX (developed and distributed by APPLE) and the Windows Operating System (developed and distributed by MICROSOFT) have enabled touch gestures.

According to an embodiment, a Control Companion app 500 may enable a user to use an interface device to control various features of a software instance that is operating on a computing device. For example, the Control Companion app may enable a user to control a Petrel software camera using touch gestures (a Petrel software camera may enable a user to view E&P data from one or more viewpoints).

In an embodiment, touch operations, including, without limitation, “pinch-to-zoom” and “two-finger rotate,” may be used to control a Petrel software camera related to E&P interpretation models and information. Accordingly, an aspect of the Control Companion app includes enabling a user to use an interface device to “remotely” control a Petrel software instance executing on a computing device. This may be useful, for example, during a presentation, or any other situation where a user desires to use a touch interface for interacting with an instance of Petrel software operating on a computing device. Action-related data may also be sent from the computing device executing the Petrel software instance to the interface device. For example, action-related data may include event data (e.g., the computing device may inform the interface device that an operation has occurred), or other data related to an action (e.g., the computing device may send graphical or text data that describes user-interface state).

In another embodiment, a touch operation may be used to control a view related to a Petrel camera. In such an embodiment, a touch operation performed on an interface device might not change the view of the Petrel camera on another computing device, but instead allow the user to manipulate a separate set of information related to the current view of the Petrel camera. In an embodiment, such separate data may reside on the interface device.

As an example, a user may choose a 2D seismic plane in Petrel software operating on a computing device to display an abstraction of the plane via an interface device. The user may then manipulate and change the view of the plane within the interface device without affecting the view of the Petrel camera. Manipulation of the plane may be facilitated via user interface controls presented by the interface device. Such user interface controls may include dialog boxes for text entry, slider bars, wheels, maps, etc.

According to another example, a user may change one or more color values related to the plane displayed via the interface device. In an embodiment, the possible color values may be presented to the user via a color map, or other user interface element. The interface device may allow the user to receive visual feedback related to the desired changes. Although the abstraction of the plane may be separated from the view of the Petrel camera, in an embodiment, a user may apply changes made to the abstraction of the plane back to the Petrel model (i.e., synchronizing one or more views between an interface device and another computing device).

Another aspect of Control Companion app functionality may include well correlation functionality. For example, a computing device running a Petrel software instance may display a 3D canvas, and an interface device may be configured to display a 2D well correlation log. A user may use an interface device to identify one or more points related to a well associated with the well correlation log.

Other aspects of embodiments of the present disclosure may include using an interface device and related touch controls to supplement control of a Petrel software instance in a way that is more efficient than what may be available via a traditional keyboard and/or mouse interface paradigm.

### Tool Companion App

A Petrel software user interface may be divided according to a process-based hierarchy. A Seismic Interpretation process is just one example of a process-based hierarchy in Petrel software. In an embodiment, when a user initiates the Seismic Interpretation mode in Petrel software, the user interface may display toolbars relevant to seismic interpretation. Selecting an interpretation tool from the toolbar may involve a further toolbar option so that the user may choose the mode for a tool. Each one of these change-of-state operations may involve mouse movement and button clicks. Furthermore, each toolbar may take up screen space related to the Petrel software GUI. Accordingly, it may involve miniaturization of one or more toolbars related to a Petrel software GUI in order to maximize the interpretation area. However, a result of this is that it may be harder to identify one or more icons present on a toolbar if the icons are too small.

In an embodiment, a Tool Companion app 600 may visually reproduce one or more toolbars 604a-e displayed on a GUI of a Petrel software instance running on a computing device, so that the toolbars may be presented in a larger scale. This may make the toolbars clearer and easier to read and understand, and thereby may extend GUI screen space without sacrificing functionality.

According to another aspect of the present disclosure, a user may execute touch gestures via a touch interface to change how an interface device displays the toolbars. This may be helpful with respect to certain toolbar elements, such as toggle buttons, which may be more efficient to manipulate using a touch-based input than using keyboard-based and/or mouse-based controls. For example, one or more of the following touch gestures to may facilitate user interaction with various toolbar elements: swipe to vertically scroll, drag to reorganize toolbars and elements, and swipe to switch toolbar pages.

According to an embodiment, a user may create a custom GUI that associates one or more gestures with one or more toolbars and/or other functionality available through a Petrel software instance. For example, a custom interface may allow a user to draw visual representations of various shortcuts (e.g., keyboard and/or mouse shortcuts, macros, etc.), and organize the representations in one or more groups. For instance, a user may group one or more toolbars related to reservoir engineering tasks together in a custom user interface. The ability to build a custom user interface enables a user to build its own “palette” of various toolbar items and/or data elements. This ability to customize various user interface elements available via a Petrel software instance may optimize a user's experience, and may reduce the time a user may spend searching for certain user interface elements.

The Tool Companion app may also contain a timeline function. In an embodiment, a timeline may be positioned in at a predetermined position on a screen displaying output of a Petrel software instance. A timeline may provide a user with the ability to play, pause, stop, or jump to a next time interval with respect to E&P data. The Tool Companion app may include one or more timelines that are organized in a manner that extends the usable user interface area offered by a Petrel software instance.

### Help Companion App

Whether a user is an expert or a beginner user of Petrel software, such user may at some point need to reference documentation. An expert might use the documentation as a technical reference, while another user with less experience might need to read documentation related to an entire process. The use of documentation may be analogized to a cookbook where an expert chef wants to confirm a detail and a beginner may need to follow each instruction carefully and read detailed explanations of each step.

In an embodiment, the Help Companion app 700 may serve as a cookbook for Petrel software users. The touch interface may facilitate scrolling and navigation, which may reduce time needed to find information. In addition, the interface software may allow a user to add additional usable screen space to what is already provided by a GUI related to a Petrel software instance executing on a computing device. This may reduce screen clutter, and enable a user to avoid tabbing between windows, and may thereby allow a user to focus on a task.

According to an embodiment, an at least substantially real-time connection may be established between interface software and a software instance operating on a computing device. An at least substantially real-time connection may enable the exchange of information between the interface software and the software instance, and may thereby enable context-sensitive help.

In an embodiment, a Petrel plug-in may be adapted to facilitate exchange of information between the interface software and a Petrel software instance. For example, when a user clicks on an object or performs some other action with respect to a Petrel instance, the plug-in may send information related to the action to the interface software. The interface software may search and identify documentation related to the action.

In another embodiment, when a user wishes to remain on a documentation page, the user may “freeze” the context-sensitive help feature, or may split the screen of the interface software so that it displays both context-sensitive documentation and “bookmarked” documentation.

The Help Companion app can also implement a plurality of context-sensitive modes, such as well-formatted context and unformatted context. With respect to well-formatted context, certain software functionality may have explicit documentation assigned to them. As an example of well-formated context mode, information relating to certain topics may have a devoted page, so that when a user requests help for such functionality, the user may be directed to pre-determined documentation. However, with unformatted context, documentation may be less structured in that a user may be directed to different pages depending on a context of the object. As an example of unformatted context mode, a plane is a generic object and belongs to several domains, so when a user requests documentation related to a plane, the user may be directed to different documentation depending on the domain. In an embodiment, the Help Companion App may be configured to automatically determine the domain and direct the user to the context-specific documentation.

The user may also annotate help content provided by the Help Companion app. For example, the user may mark-up and/or bookmark certain content. The various customization aspects of the Help Companion app described herein may allow a user to create personalized help content. At least a portion of the personalized help content (e.g., the user annotations) may be shared between the Help Companion app, and Petrel software documentation existing on another computing device, such as a desktop, intranet, Internet, etc.

Another aspect of the Help Companion app may also include links to certain functionality within the actual help content. For example, if a user searches for help related to certain functionality, the Help Companion app may include images or other representative identifiers related to the desired functionality that are links that may be clicked by the user to execute related functionality.

Method for Interacting with E&P Data

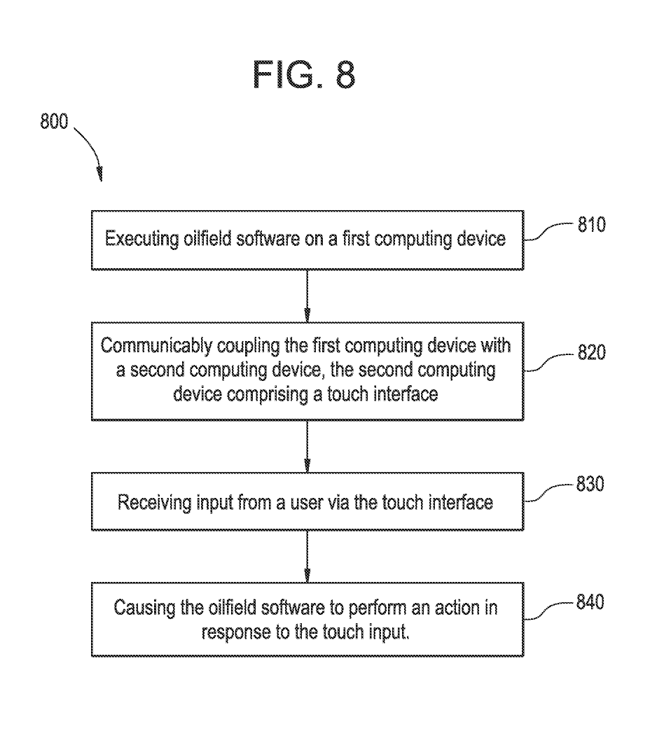

FIG. 8 illustrates a method 800 for interacting with E&P data according to an embodiment of the present disclosure. According to an embodiment, method 800 may include a block 810 that includes executing oilfield software on a first computing device, and a block 820 that includes communicably coupling the first computing device with a second computing device, the second computing device comprising a touch interface. Further, method 800 may include a block 830 that includes receiving input from a user via the touch interface. Method 800 may also include a block 840 that includes causing the oilfield software to perform an action in response to the touch input.

Method for Collaborating with E&P Data

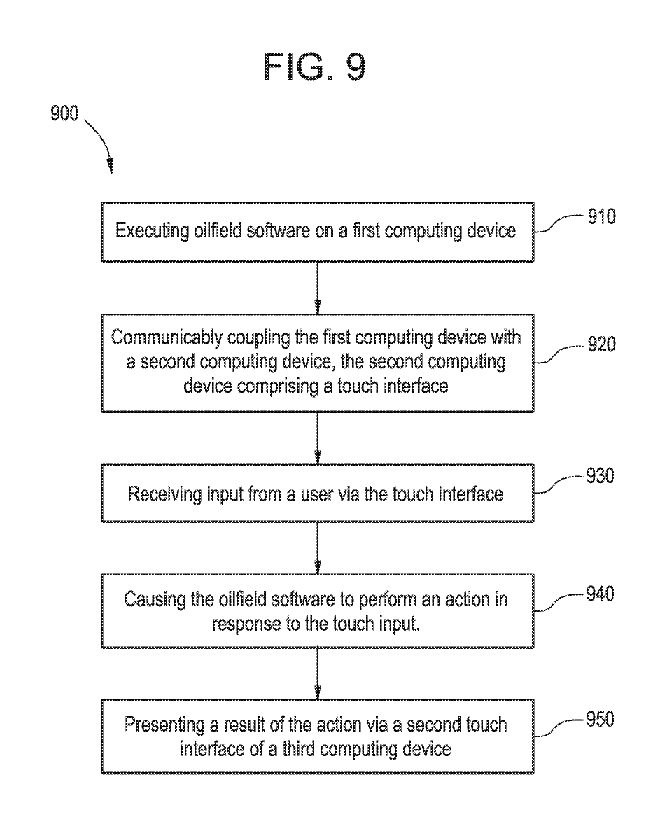

FIG. 9 illustrates a method 900 for collaborating with E&P data according to an embodiment of the present disclosure. According to an embodiment, method 900 may include a block 910 that includes executing oilfield software on a first computing device, and a block 920 that includes communicably coupling the first computing device with a second computing device, the second computing device comprising a touch interface. Further, method 800 may include a block 930 that includes receiving input from a user via the touch interface. Method 900 may also include a block 940 that includes causing the oilfield software to perform an action in response to the touch input. Additionally, method 900 may include a block 950 that includes presenting a result of the action via a second touch interface of a third computing device.

### Method for Implementing a Short Range Communication Protocol

In an embodiment, a short range communication protocol may be used to enable sharing petrotechnical data among a plurality of computing devices. For example, a petrotechnical application may be executed on a first computing device to enable a first user to build a model. The model may contain a variety of petrotechnical data and the corresponding context (e.g., display parameters, scale, annotation, etc.). A second user of a second computing device may desire to receive a certain piece of data and/or corresponding context in the second computing device for further operation (e.g., inspection, sharing, showing, etc.). In an embodiment, the first user and the second user may be the same person, or may be different people.

The first user may use the first computing device to select data to be shared with a second computing device (e.g., an interface computing device). To initiate sharing of the selected data, the second computing device may be brought within a certain proximity with respect to the first computing device. The first and second computing devices may establish a two-way communication link using a short range communication protocol (e.g., NFC, RFID, etc.). The protocol may verify credentials, so that certain devices/users are allowed to establish the connection between the first and second computing devices. Once validation is successful, data transfer may occur between the first and second computing devices such that an associated application may start on the second computing device and data may be displayed on the second computing device with the corresponding context.

The second user can use the second computing device to interact with the data transferred (e.g., share it, show it, modify it, etc.). Similarly, later on, the second user may desire to synchronize changes made to the data between the first and second computing devices. To do so, the second user may bring the second computing device within a certain proximity to the first computing device. The protocol may once again verify that the credentials are valid and may establish the connection once the credentials are verified. Once the credentials are verified, data that has changed as a result of the second user's use of the second computing device may be synchronized between the first and second computing devices.

In another embodiment, a short range protocol may be used to enable a user of the second device to control software that is executing on the first device (e.g., similar to the Control Companion App, as described herein).

Various aspects of the example embodiments disclosed herein may be customized for specific use cases. For example, in an example embodiment the reservoir model may include a coal bed methane (CBM) model. In another example embodiment, the simulator may calculate well drilling priorities in response to a drilling request. In yet another example embodiment, it may be advantageous in certain situations to base the allocation of well production targets on look-ahead potentials, rather than instantaneous potentials. Example embodiments disclosed herein may be adapted to support such applications.

### Computer System for Oilfield Application

FIG. 10 illustrates a computer system 1000 into which implementations of various technologies and techniques described herein may be implemented. In one implementation, computing system 1000 may be a conventional desktop or a server computer, but it should be noted that other computer system configurations may be used.

The computing system 1000 may include a central processing unit (CPU) 1021, a system memory 1022 and a system bus 1023 that couples various system components including the system memory 1022 to the CPU 1021. Although only one CPU is illustrated in FIG. 10, it should be understood that in some implementations the computing system 1000 may include more than one CPU. The system bus 1023 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 1022 may include a read only memory (ROM) 1024 and a random access memory (RAM) 1025. A basic input/output system (BIOS) 1026, containing the basic routines that help transfer information between elements within the computing system 1000, such as during start-up, may be stored in the ROM 1024.

The computing system 1000 may further include a hard disk drive 1027 for reading from and writing to a hard disk, a magnetic disk drive 1028 for reading from and writing to a removable magnetic disk 1029, and an optical disk drive 1030 for reading from and writing to a removable optical disk 1031, such as a CD ROM or other optical media. The hard disk drive 1027, the magnetic disk drive 1028, and the optical disk drive 1030 may be connected to the system bus 1023 by a hard disk drive interface 1032, a magnetic disk drive interface 1033, and an optical drive interface 1034, respectively. The drives and their associated computer-readable media may provide nonvolatile storage of computer-readable instructions, data structures, program modules and other data for the computing system 1000.

Although the computing system 1000 is described herein as having a hard disk, a removable magnetic disk 1029 and a removable optical disk 1031, it should be appreciated by those skilled in the art that the computing system 1000 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 1000. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. Combinations of any of the above may also be included within the scope of computer readable media.

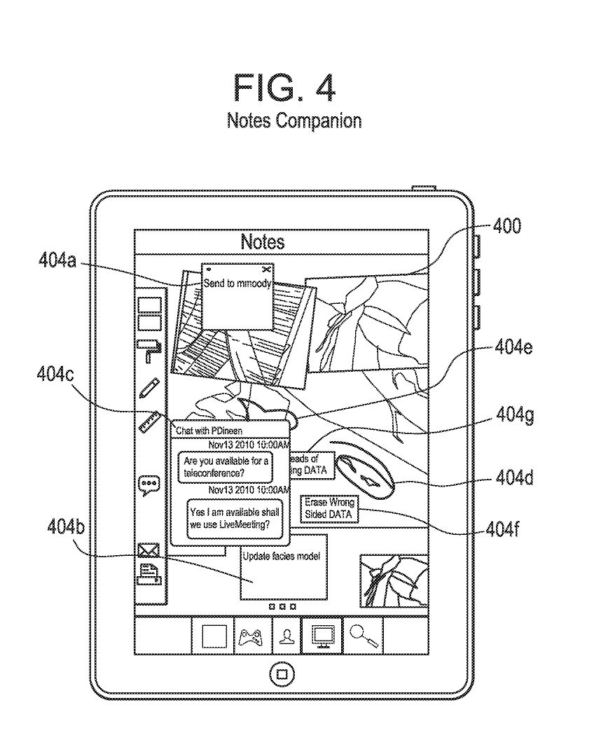

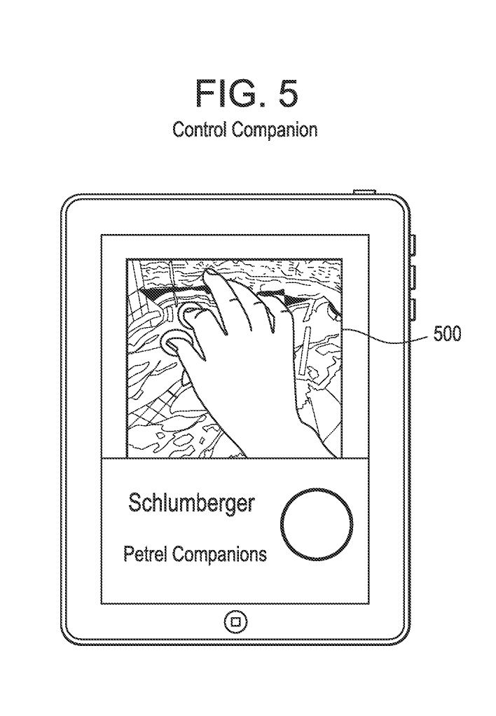

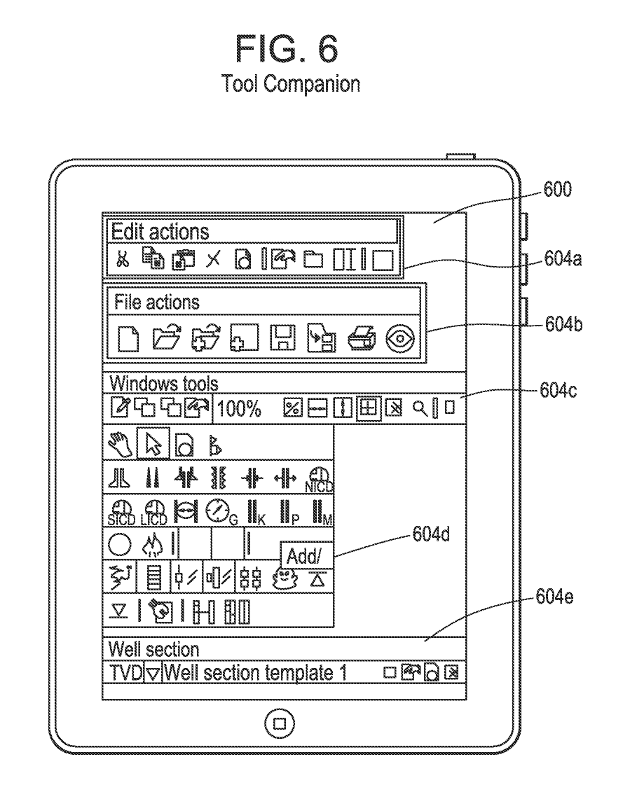

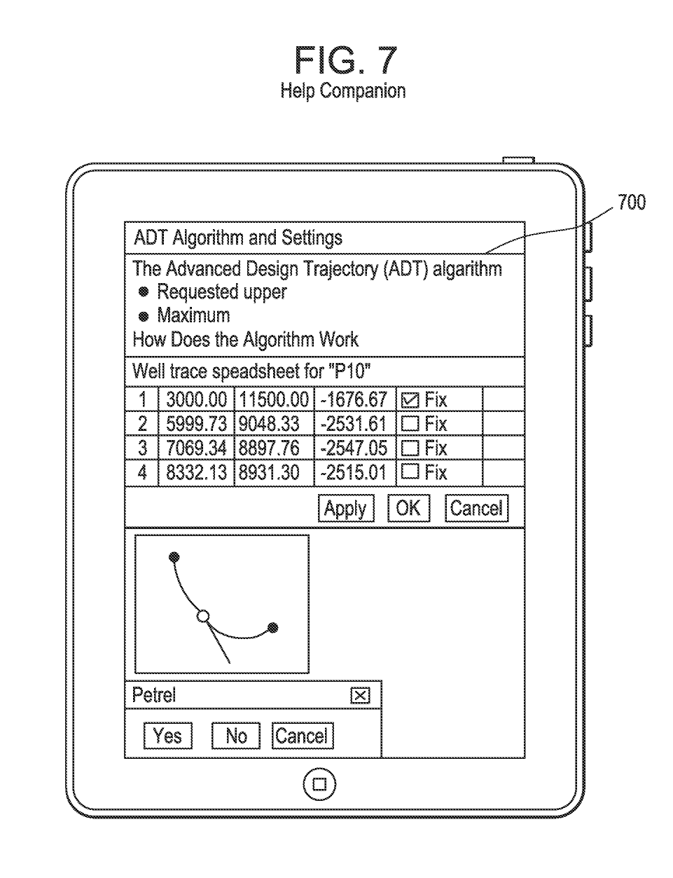

A number of program modules may be stored on the hard disk 1027, magnetic disk 1029, optical disk 1031, ROM 1024 or RAM 1025, including an operating system 1035, one or more application programs 1036, program data 1038 and a database system 1055. The operating system 1035 may be any suitable operating system that may control the operation of a networked personal or server computer, such as Windows® XP, Mac OS® X, Unix-variants (e.g., Linux® and BSD®), and the like. In one implementation, plug-in manager 420, oilfield application 410, the plug-in quality application and the plug-in distribution application described in FIGS. 4-9 in the paragraphs above may be stored as application programs 1036 in FIG. 10.

A user may enter commands and information into the computing system 1000 through input devices such as a keyboard 1040 and pointing device 1042. Other input devices may include a microphone, joystick, game pad, satellite dish, scanner, or the like. These and other input devices may be connected to the CPU 1021 through a serial port interface 1046 coupled to system bus 1023, but may be connected by other interfaces, such as a parallel port, game port or a universal serial bus (USB). A monitor 1047 or other type of display device may also be connected to system bus 1023 via an interface, such as a video adapter 1048. In addition to the monitor 1047, the computing system 1000 may further include other peripheral output devices such as speakers and printers.

Further, the computing system 1000 may operate in a networked environment using logical connections to one or more remote computers 1049. The logical connections may be any connection that is commonplace in offices, enterprise-wide computer networks, intranets, and the Internet, such as local area network (LAN) 1051 and a wide area network (WAN) 1052. The remote computers 1049 may each include application programs 1036 similar to that as described above. In one implementation, the plug-in quality application (i.e., performing method 500) stored in plug-in quality center 460 may be stored as application programs 1036 in system memory 1022. Similarly, the plug-in distribution application (i.e., performing method 600) stored in plug-in distribution center 470 may be stored as application programs 1036 in remote computers 1049.

When using a LAN networking environment, the computing system 1000 may be connected to the local network 1051 through a network interface or adapter 1053. When used in a WAN networking environment, the computing system 1000 may include a modem 1054, wireless router or other means for establishing communication over a wide area network 1052, such as the Internet. The modem 1054, which may be internal or external, may be connected to the system bus 1023 via the serial port interface 1046. In a networked environment, program modules depicted relative to the computing system 1000, or portions thereof, may be stored in a remote memory storage device 1050. It will be appreciated that the network connections shown are embodiments and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
executing oilfield software on a first computing device;
communicably coupling the first computing device with a second computing device, the second computing device comprising a touch interface;
receiving input from a user via the touch interface; and
causing the oilfield software to perform an action in response to the input.

2. The method of claim 1, further comprising:
presenting a result of the action via a second touch interface of a third computing device communicably coupled to at least one of the first and second computing devices.

3. The method of claim 2, further comprising:
exporting information related to a virtual workspace associated with exploration or production model data to a file; and
sharing the file with at least one of the second and third computing devices.

4. The method of claim 1, wherein communicably coupling the first and second computing devices comprises establishing a communication link using a short range protocol.

5. The method of claim 1, wherein the action performed in response to receiving the touch input comprises managing a plurality of graphical user interface windows related to the oilfield software.

6. The method of claim 1, wherein the input is a first input, the user is a first user, and the touch interface is a first touch interface, and further comprising:
communicably coupling either the first computing device or the second computing device with a third computing device;
receiving a second input from a second user; and
causing the oilfield software to perform a second action in response to the second input.

7. The method of claim 1, wherein interface software executing on the second computing device extends a user interface presented by the oilfield software.

8. The method of claim 1, further comprising sharing an electronic note related to exploration or production data between the second computing device and a third computing device.

9. The method of claim 1, further comprising importing a first dataset to the second computing device;
applying an attribute to at least a portion of the first dataset using the second computing device; and
applying the attribute to a second data set based upon the portion of the first dataset.

10. The method of claim 1, wherein the action comprises modifying a first documentation related to the oilfield software stored at the second computing device; and further comprising modifying a second documentation stored at the first computing device.

11. The method of claim 1, further comprising presenting a toolbar related to the oilfield software via the touch interface when the user executes a gesture via the touch interface.

12. The method of claim 1, further comprising presenting documentation, in context with a window related to the oilfield software, via the touch interface.

13. A system, comprising:
a first computing device configured to execute oilfield software; and
a second computing device communicably coupled to the first computing device, the second computing device comprising a touch interface, wherein the touch interface is configured to receive input from a user, and wherein
the first computing device is configured to cause the oilfield software to perform an action in response to the input.

14. The system of claim 13, further comprising:
a third computing device communicably coupled to at least one of the first and second computing devices, the third computing device comprising a second touch interface configured to present a result of the action.

15. The system of claim 14, wherein the first, second, and third computing devices are communicably coupled to a virtual workspace configured to store information associated with exploration or production model data.

16. The system of claim 13, further comprising a third computing device configured to share an electronic note related to exploration or production data with the second computing device.

17. The system of claim 13, wherein the second computing device comprises software adapted to import a first dataset to the second computing device, and apply an attribute to at least a portion of the first dataset imported, and apply the attribute to a second data set based upon the portion of the first dataset.

18. The system of claim 13, wherein the second computing device comprises software adapted to present documentation, in context with a window related to the oilfield software, to a user via the touch interface.

19. One or more computer-readable media comprising computer-executable instructions to instruct a first computing device and a second computing device comprising a touch interface to perform a process, the process comprising:
executing oilfield software on the first computing device;
communicably coupling the first computing device with the second computing device;
receiving input from a user via the touch interface; and
causing the oilfield software to perform an action in response to the input.

20. The computer-readable media of claim 19, wherein the process further comprises:
exporting information related to a virtual workspace associated with exploration or production model data to a file; and
sharing the file with at least one of the second computing device and a third computing device communicably coupled to at least one of the first and second computing devices.
